(19) United States
(12) Patent Application Publication
(10) Pub. No.: US 2009/0021358 A1
(43) Pub. Date: Jan. 22, 2009

(54) LANE DEVIATION WARNING SYSTEM

(76) Inventors: Jae Kwan Lee, Yongin-si (KR); Sung Bo Sim, Anyang-si (KR); Ryuk Kim, Hwaseong-si (KR); Je Hun Ryu, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/972,355

(22) Filed: Jan. 10, 2008

(30) Foreign Application Priority Data
Jul. 16, 2007 (KR) 10-2007-0071245

(51) Int. Cl. B60Q 1/00

(52) U.S. Cl. 340/436

(57) ABSTRACT

The lane deviation warning system is provided, including a traveling lane detection unit for detecting a traveling lane; an operation detection unit connected to at least a sensor and for detecting motion of the vehicle in real time; a controller for controlling to calculate and output a traveling lane deviation time point of the vehicle according to data detected through the traveling lane detection unit and the operation detection unit by setting at least a critical line of the traveling lane based on data detected through the traveling lane detection unit, and to output a corresponding warning signal when the vehicle reaches at least a preset critical line; and a warning device driver for controlling to drive at least one of a first warning means and a second warning means according to a warning signal output from the controller.

This application claims the benefit of Korean Application No. 10-2007-0071245, filed on Jul. 16, 2007 in the Korean Intellectual Property Office, the disclosure of which is incorporated herein by reference.

### BACKGROUND OF THE INVENTION

1. Field of the Invention

The present invention relates to a lane deviation warning system, and more particularly, to a lane deviation warning system for warning in advance traveling lane deviation in order to prevent a collision accident and a rear-end collision accident generating when a vehicle deviates a traveling lane due to a driver's carelessness or sleepiness.

2. Description of the Related Art

In general, a lane deviation warning system includes a camera provided at the front of a vehicle and a warning output unit connected to the camera and for outputting warning sound. The camera is a charge-coupled device (CCD) camera and detects whether the vehicle deviates a lane by acquiring image data of information on a forward direction of the road in real time. The warning output unit analyzes road image data output by the camera in real time and outputs a warning signal in order to notify a driver of an emergency situation when the vehicle deviates a lane.

However, the conventional lane deviation warning system having the above-described configuration can detect differently from an actual position since it determines whether a vehicle deviates a lane with only a detection value detected through a camera, thereby deteriorating user reliability.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and the present invention provides a lane deviation warning system that can notify a user in advance at least a traveling lane deviation time point in driving and warn in advance before deviating the critical line.

According to an aspect of the present invention, there is provided a lane deviation warning system including: a traveling lane detection unit for detecting a traveling lane while a vehicle travels; an operation detection unit monitoring at least a sensor to detect motion of the vehicle in real time; a controller for controlling to calculate and output at least a traveling lane deviation time point of the vehicle according to data detected through the traveling lane detection unit and the operation detection unit by setting at least a critical line of the traveling lane based on data detected through the traveling lane detection unit, and to output a corresponding warning signal when the vehicle reaches at least a preset critical line; and a warning device driver for controlling at least one of a first warning means and a second warning means according to a warning signal output from the controller.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWING

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram illustrating a configuration of a lane deviation warning system according to an exemplary embodiment of the present invention;

FIG. 2 is a diagram illustrating an operating of a lane deviation warning system according to an exemplary embodiment of the present invention;

FIG. 3 is a diagram additionally illustrating the operating of FIG. 2;

FIG. 4 is a diagram illustrating an operating of an operation detection unit according to an exemplary embodiment of the present invention;

FIG. 5 is a diagram illustrating an operating of a lane deviation warning system according to another exemplary embodiment of the present invention; and

FIG. 6 is a flowchart illustrating an operating of a lane deviation warning system according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENT

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments according to the present invention will be described in detail with reference to the accompanying drawings.

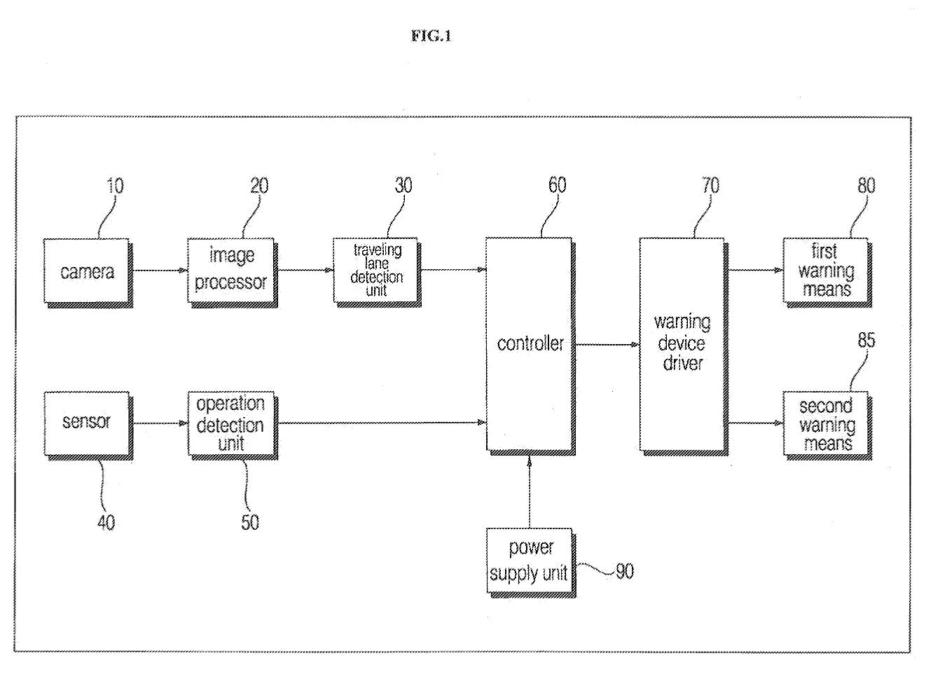

FIG. 1 is a block diagram illustrating a configuration of a lane deviation warning system according to an exemplary embodiment of the present invention.

As shown in FIG. 1, the lane deviation warning system includes a camera 10, an image processor 20 for processing an image signal that is input through the camera 10, a traveling lane detection unit 30 for detecting a traveling lane of a vehicle through a photographed image, at least a sensor 40, an operation detection unit 50 for detecting motion of the vehicle in real time through the connected sensors 40, a controller 60 for controlling to calculate and output at least a traveling lane deviation time point of the vehicle according to data detected through the traveling lane detection unit 30 and the operation detection unit 50 by setting at least a critical line of the traveling lane based on data detected through the traveling lane detection unit 30, and to output a corresponding warning signal when the vehicle reaches at least a preset critical line; and a warning device driver 70 for controlling at least one of a first warning means 80 and a second warning means 85 according to a warning instruction signal output from the controller 60. Further, the lane deviation warning system includes a power supply unit 90 for supplying driving power thereof.

The sensors 40 include a vehicle speed sensor for detecting a speed of the vehicle, an yaw rate sensor for detecting an angular velocity of the vehicle, a lateral acceleration sensor for detecting lateral acceleration, and a steering angle sensor for detecting a steering velocity, a steering direction, and a steering angle of a handle, and further includes a sensor for detecting an operation of a turn signal lamp, a wiper, etc.

In an exemplary embodiment, the controller 60 sets at least a critical line within a predetermined distance from a traveling lane. The critical line may include a first critical line that is set inside the traveling lane and a second critical line that is set outside the traveling lane. The controller 60 outputs a first warning signal to the warning device driver 70 when the vehicle reaches the first critical line and outputs a second warning signal to the warning device driver 70 when the vehicle reaches the second critical line. Therefore, the warning device driver 70 controls the first warning means 80 when the first warning signal is instructed from the controller 60 and controls the second warning means 85 when the second warning signal is instructed from the controller 60.

The first warning means 80 may be a haptic warning device and performs haptic warning through at least one of an electrical safety belt and a steering actuator. The first warning means 80 may output vibration from a handle and a seat using a vibration motor, etc. The second warning means 85 may include a warning sound output device, include a sound output means such as a buzzer and a speaker, and output warning sound through the sound output means. When the second warning signal is instructed, the first warning means 80 and the second warning means 85 may be simultaneously driven in an embodiment.

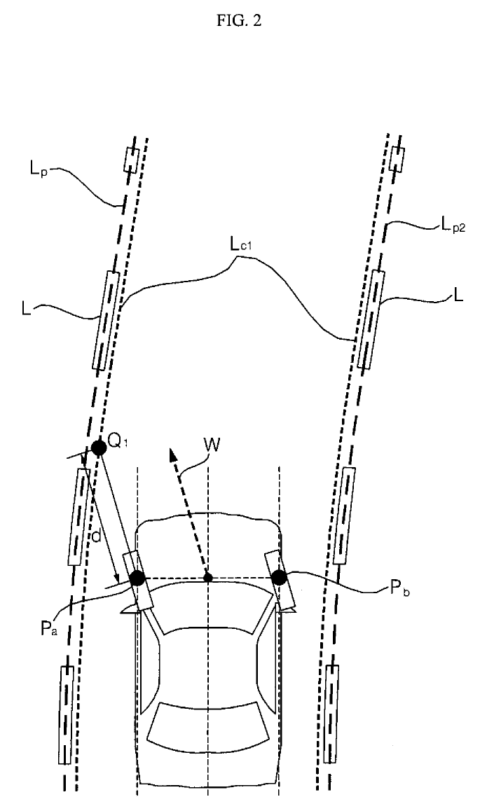

The lane deviation warning system having the above-described configuration is described in detail with reference to FIG. 2.

FIG. 2 is a diagram illustrating an operating of a lane deviation warning system according to an exemplary embodiment of the present invention.

Referring to FIG. 2, the controller 60 detects a traveling speed V and a traveling direction W of the vehicle through at least a sensor 40 when the vehicle travels. In this example, the vehicle is directed left. The controller 60 sets a central point (Pₐ or P_{b}) of any one of a left front wheel and a right front wheel as a reference point respectively. Further, the controller 60 through the traveling lane detection unit 30 recognizes a lane L located in the traveling direction W captured by operating the camera 10 while traveling and sets a first critical line L_{C1} of the left traveling lane L_{P1}. The left traveling lane L_{P1} may be detected by setting the middle line of the left lane L as the left traveling lane L_{P1}.

The controller 60 calculates a distance d, i.e. an estimated deviation distance d up to a critical point Q₁. The estimated deviation distance d is a distance measuring between a critical point Q₁ positioned on the first critical line L_{C1} in the traveling direction W and a reference point Pa in this example. From this date, the controller 60 may detect a traveling lane deviation time point t_{d} with an equation

$${t}_{d} = \frac{d}{V}$$

obtained by dividing the calculated estimated deviation distance d by a driving speed V of the vehicle. That is, in this example, a central point Pₐ is a reference point set to a left front wheel adjacent to a left lane L of a traveling direction W among a left front wheel and a right front wheel. In other words, when a traveling direction W of the vehicle faces a left lane, a central point Pₐ of the left front wheel is set to a reference point. In contrast, when a traveling direction W of the vehicle faces a right lane, a reference point is changed such that a central point P_{b} of the right front wheel is set to a reference point and the critical line L_{C1} is changed to the critical line positioned inside the right traveling lane L_{P2} as set forth below. The right traveling lane L_{P2} may also be detected by setting the middle line of the right lane L as the right traveling lane L_{P2}.

Therefore, the controller 60 outputs the calculated estimated deviation distance d and the traveling lane deviation time point t_{d} in accordance with the critical point Q1 positioned on the critical line L_{c1} and outputs a corresponding warning signal to the warning device driver 70 when the reference point, i.e., Pₐ and P_{b} deviate the critical line L_{C1} disposed left or right side of the vehicle but inside the traveling lane Lp. The warning device driver 70 controls at least one of the first warning means 80 and the second warning means 85 to be driven according the input warning instruction of the controller 60.

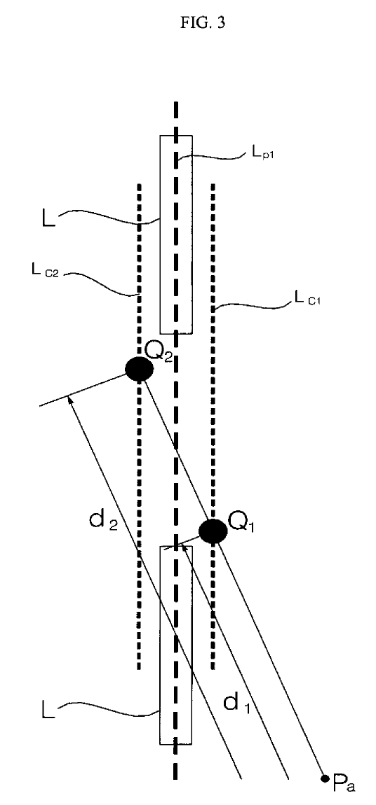

As another embodiment, FIG. 3 is a diagram additionally illustrating the operating of FIG. 2 in detail.

Referring to FIG. 3, when a central point Pa of the left front wheel, i.e., Pa is a reference point, a critical line that is positioned inside the left traveling lane L_{P1} is set as a first critical line L_{C1}, and a critical line that is positioned outside the left traveling lane L_{P1} is set as a second critical line L_{C2}. A point wherein a line extending in a traveling direction W from the reference point Pa intersects with the first critical line L_{C1} is set as a first critical point Q₁. A point wherein a line extending in a traveling direction W from the reference point Pa intersects with the second critical line L_{C2} is set as a second critical point Q₂,

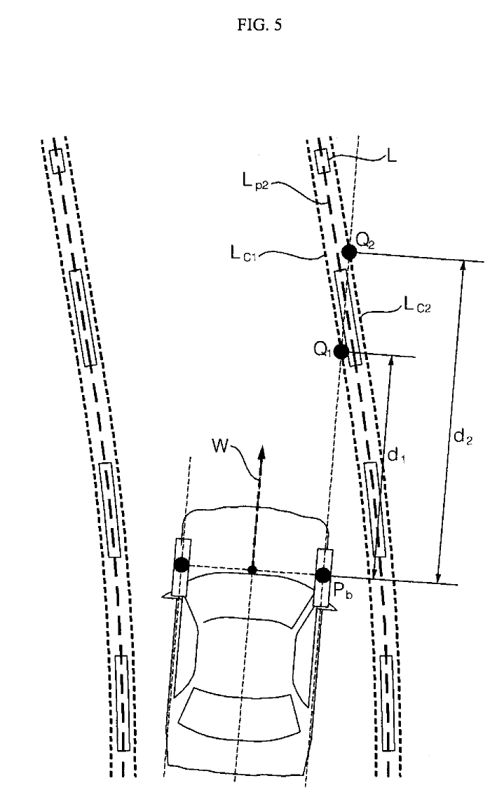

According to a traveling direction W of the vehicle, the first critical point Q1 and the second critical point Q2 change on occasion. As an exemplary embodiment, FIG. 5 shows the first critical point Q1 and the second critical point Q2 in case that a traveling direction W of the vehicle is orientated right.

A distance between the reference point Pa and the first critical point Q1 is referred to as a first estimated deviation distance d1, and a distance between the reference point Pa and the second critical point Q2 is referred to as a second estimated deviation distance d2. The controller 60 calculates a traveling lane deviation time point t_{d} using the first estimated deviation distance d1 and the second estimated deviation distance d2 and a traveling speed V. Accordingly, in this example, the controller 60 may output two traveling lane deviation time points t_{d}, corresponding to the first estimated deviation distance d1 and the second estimated deviation distance d2.

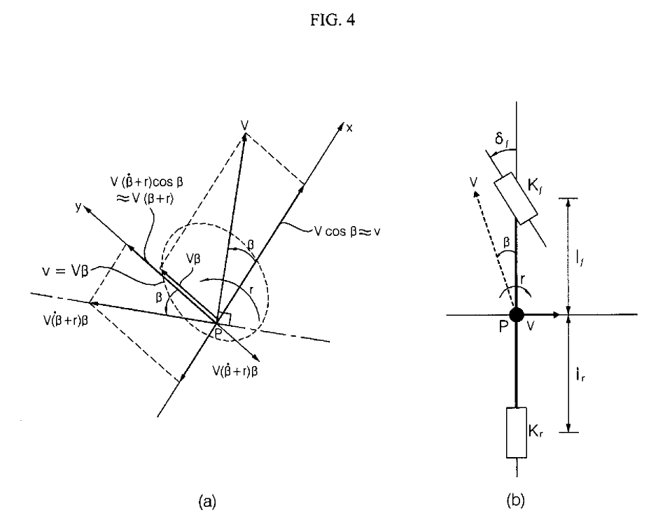

FIG. 4 is a diagram illustrating an operating of an operation detection unit 50 according to an exemplary embodiment of the present invention.

Referring to FIG. 4, the operation detection unit 50 detects motion of the vehicle based on data applied from the connected plurality of sensors 40.

FIG. 4(a) shows an example detecting motion of an actual vehicle based on a front wheel and a rear wheel of a vehicle model, and FIG. 4(b) shows a mathematic model for detecting motion of the actual vehicle with reference to FIG. 4(a). This is represented by Equation 1.

$$- \frac{2 \cdot {K}_{f}}{m} ( \frac{v}{V} + \frac{{I}_{f}}{V} \cdot r - {δ}_{f} ) - \frac{2 \cdot {K}_{f}}{m} ( \frac{v}{V} + \frac{{I}_{r}}{V} \cdot r ) - V \cdot r ) = - \frac{2 {K}_{f} \cdot {I}_{f}}{I} ( \frac{v}{V} + \frac{{I}_{f}}{V} \cdot r - {δ}_{f} ) + \frac{2 \cdot {K}_{r} \cdot {I}_{r}}{I} ( \frac{v}{V} + \frac{{I}_{r}}{V} \cdot r ) \qquad Equation 1$$

where,
δ_{f} is a front wheel angle (=steering angle/steering ratio),
v is lateral acceleration,
r is a yaw rate,
K_{f} is front wheel cornering power,
Kᵣ is rear wheel cornering power,
V is a speed of the vehicle,
I_{f} is a distance between the front wheel and the center of mass of the vehicle,
Iᵣ is a distance between the rear wheel and the center of mass of the vehicle,
m is a weight of vehicle, and
I is a moment of inertia.

The above value may be confirmed through data detected using at least a sensor 40. Further, β can be obtained from v=Vβ where β is a travel angel of an actual vehicle.

Therefore, the controller 60 can detect motion such as a traveling direction W of an actual vehicle through FIGS. 4(a) and 4(b) and Equation 1.

FIG. 5 is a diagram illustrating an operating of a lane deviation warning system according to another exemplary embodiment of the present invention. FIG. 5 illustrates an exemplary embodiment when a traveling direction W faces a right traveling lane L_{P2} based on a right front wheel, unlike FIG. 3.

Referring to FIG. 5, when a traveling direction W is a linear direction of the vehicle, the controller 60 detects a first critical point Q1 and a second critical point Q2. The first critical point Q1 is a point wherein a line extending in a traveling direction W from a reference point Pb to the first critical line L_{C1} positioned inside the right traveling line Lp₂ intersects with the first critical line L_{C1}. The second critical point Q2 is a point wherein a line extending in a traveling direction W from a reference point Pb to the second critical line L_{C2} positioned outside the right traveling line Lp2 intersects with the second critical line L_{C2}. Unlike FIG. 3, a critical line that is set within a predetermined distance at a left side of the right traveling lane L_{P2} is the first critical line L_{C1}, and a critical line that is set within a predetermined distance at a right side of the right traveling lane L_{P2} is the second critical line L_{C2}. The controller 60 may calculate each estimated deviation distance (d1, d2), which is a distance between the detected first critical point Q1 and the reference point Pb and a distance between the second critical point Q2 and the reference point Pb, thereby detecting a traveling lane deviation time point t_{d} for each estimated deviation distance (d1, d2). The controller further may calculate the difference between a traveling lane deviation time point for the first critical point Q1 and a traveling lane deviation time point for the second critical point Q2.

If the vehicle reaches the preset first critical line L_{C1}, the controller 60 may output a first warning signal to the warning device driver 70, and if the vehicle reaches the preset second critical line L_{C2}, the controller 60 may output a second warning signal to the warning device driver 70.

An operation of the present invention having the above-described configuration is as follows.

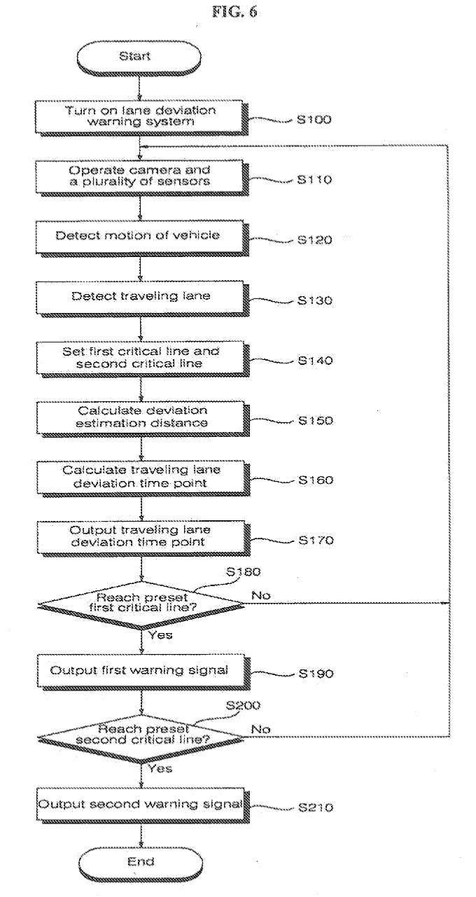

FIG. 6 is a flowchart illustrating an operating of a lane deviation warning system according to an exemplary embodiment of the present invention.

As shown in FIG. 6, when the lane deviation warning system is turned on (S100), the controller 60 controls the connected camera 10 and at least a sensor 40 to be operated (S110).

The operation detection unit 50 detects motion of the vehicle in real time using detected data according to an operation of at least a sensor 40 (S120).

The traveling lane detection unit 30 detects a traveling lane L_{P1} or L_{P2}, depending on the traveling direction W of the vehicle, using an image photographed through the camera 10 (S130)

The controller 60 sets the first critical line L_{C1} and the second critical line L_{C2} of the traveling lane L_{P} detected through the traveling lane detection unit 30 (S140). The first critical line L_{C1} and the second critical line L_{C2} are set to sustain an interval within a predetermined distance from the detected traveling lane L_{P1}, or L_{P2}, depending on the traveling direction W of the vehicle.

The controller 60 calculates estimated deviation distances (d1, d2) according to motion of the vehicle using motion data of the vehicle detected through the operation detection unit and the first critical line L_{C1} and the second critical line L_{C2} of the traveling lane L_{P1} or L_{P2} detected through the traveling lane detection unit 30 (S150) and calculates the traveling lane deviation time point t_{d1} and/or t_{d2} (S160). In another embodiment, the difference between t_{d1} and t_{d2} also can be measured.

The calculated estimated deviation distances (d1, d2) and the traveling lane deviation time point t_{d1} and/or t_{d2} are output through an output means of the vehicle (S170). The output means includes an audio instrument, etc. and when an image output means is provided, the image output means may be used.

When the vehicle reaches preset critical line L_{C1} and/or L_{C2}, the controller 60 outputs a warning signal so that a user may easily recognize.

The controller 60 determines whether the vehicle reaches the preset first critical line L_{C1} (S110).

If the vehicle reaches the preset first critical line L_{C1}, the controller 60 outputs a first warning signal to the warning device driver 70, and the warning device driver 70 controls the first warning means 80 to operate according to the applied first warning signal (S190).

The controller 60 further determines whether the vehicle reaches the preset second critical line L_{C2} (S200). If the vehicle reaches the preset second critical line L_{C2}, the controller 60 outputs a second warning signal to the warning device driver 70 (S210). The warning device driver 70 controls the second warning means 85 to operate, or the first warning means 80 and the second warning means 85 to operate together.

As described above, according to the present invention, the lane deviation warning system detects and notifies a user of a traveling lane deviation time point according to an actual operating state of a vehicle while driving so that the user can recognize in advance the deviation time point, thereby improving user reliability, and by setting a critical line of a traveling lane, a warning can be performed in advance before deviating the critical line, so that an accident can be prevented in advance.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A lane deviation warning system of a vehicle comprising:
a traveling lane detection unit for detecting at least a traveling lane;
an operation detection unit monitoring at least a sensor and detecting motion of the vehicle in real time through the sensor;
a controller for controlling to calculate and output a traveling lane deviation time point of the vehicle according to data detected through the traveling lane detection unit and the operation detection unit by setting at least a critical line of the traveling lane based on data detected through the traveling lane detection unit, and to output a corresponding warning signal when the vehicle reaches at least a preset critical line; and
a warning device driver for controlling at least one of a first warning means and a second warning means according to a warning instruction output from the controller.

2. The lane deviation warning system of claim 1, wherein the traveling lane deviation time point t_{d} is represented by
$${t}_{d} = \frac{d}{V} \qquad Equation$$
where d is an estimated deviation distance and V is a traveling speed.

3. The lane deviation warning system of claim 2, wherein the estimated deviation distance d is a distance measuring from a deviation reference point P up to a point positioned on the critical line wherein a line extending from the deviation reference point P in the direction of a traveling direction of the vehicle intersects with the critical line.

4. The lane deviation warning system of claim 3, wherein the deviation reference point P is set based on one of a left front wheel and a right front wheel of the vehicle.

5. The lane deviation warning system of claim 1, wherein the critical line is set within a predetermined distance with respect to the traveling lane and comprises a first critical line set inside the traveling lane and a second critical line set outside the traveling lane.

6. The lane deviation warning system of claim 5, wherein the controller controls to output a warning instruction for controlling the first warning means when the vehicle reaches the first critical line.

7. The lane deviation warning system of claim 5, wherein the critical line is set within a predetermined distance with respect to the traveling lane and comprises a second critical line set outside the traveling lane.

8. The lane deviation warning system of claim 7, wherein the controller controls to output a warning instruction for controlling the first warning means when the vehicle reaches the first critical line and to output a warning instruction for controlling the second warning means when the vehicle reaches the second critical line.

9. The lane deviation warning system of claim 1, wherein the first warning means is a haptic warning device, and the second warning means is a warning sound output device.

10. The lane deviation warning system of claim 9, wherein the first warning means performs haptic warning using at least one of an electrical safety belt and a steering actuator.
